(19) United States
(12) Patent Application Publication
(10) Pub. No.: US 2025/0184875 A1
(43) Pub. Date: Jun. 5, 2025

(54) SYSTEMS AND METHODS FOR RADIO-FREQUENCY ADVERSARIAL DEEP-LEARNING INFERENCE FOR AUTOMATED NETWORK COVERAGE ESTIMATION

(71) Applicant: Arizona Board of Regents on Behalf of the University of Arizona, Tucson, AZ (US)

(72) Inventors: Marwan Krunz, Tucson, AZ (US); Manshaei Mohammad Hossein, Tucson, AZ (US); Sopan Sarkar, Tucson, AZ (US)

(21) Appl. No.: 18/969,125

(22) Filed: Dec. 4, 2024

Related U.S. Application Data
(60) Provisional application No. 63/605,640, filed on Dec. 4, 2023.

(51) Int. Cl. H04W 48/16; G06N 3/0475; H04B 17/318; H04W 24/02

(52) U.S. Cl. CPC H04W 48/16; G06N 3/0475; H04W 24/02; H04B 17/318

(57) ABSTRACT

Example systems and methods for radio-frequency adversarial deep-learning inference for automated network coverage estimation include a generative adversarial network (GAN) based approach for synthesizing RF maps in indoor scenarios. In some examples, a semantic map is utilized—a high-level representation of the indoor environment to encode spatial relationships and attributes of objects within the environment and guide the radio frequency (RF) map generation process. A new gradient-based loss function is introduced that computes the magnitude and direction of change in RSS values from a point within the environment. Some examples incorporate this loss function along with the antenna pattern to capture signal propagation within a given indoor configuration and generate new patterns under new configuration, antenna (beam) pattern, and center frequency.

### CROSS-REFERENCE TO RELATED APPLICATIONS

This is a non-provisional application that claims benefit to U.S. Provisional Application Ser. No. 63/605,640, filed on Dec. 4, 2023, which is herein incorporated by reference in its entirety.

### FIELD

The present disclosure generally relates to radio frequency coverage maps (RF maps); and in particular to example implementations of generative adversarial networks (GANS) to generate RF maps for unique and/or new environments or different network configurations.

### BACKGROUND

Radio-frequency (RF) coverage maps (RF maps) are of great importance in wireless communication applications such as radio network planning, resource allocation, coverage estimation, localization, handover or handoff management, interference coordination and capacity planning. However, collecting RF data and conducting site surveys is complicated due to the complex and dynamic nature of the wireless environment and the wide range of factors that can affect signal propagation. Collecting RF data requires site surveying, during which engineers consider different aspects of the coverage area, such as buildings, large objects, and walls, measure nearby cell interference, and generate RF maps. Site surveys are labor-intensive and complicated as they require carrying instruments around the measurement area and taking multiple measurements of the received signal strength (RSS) or signal-to-noise ratio (SNR). For example, it takes about 11.9 hours to survey a building of an area of 4500 m² using only 475 reference points (RP) for omnidirectional communications. It becomes even more complicated at millimeter-wave (mmW) and sub-Terahertz (sub-THz) frequencies in 5G and beyond 5G (B5G) communication systems. The signal propagation transmissions at these frequencies suffer from high atmospheric attenuation and limited penetration (and also susceptibility to shadowing, and inability to operate in non-line-of-sight (NLOS) scenarios), making cell coverage highly dependent on the environment.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1A is an illustration of a generative adversarial network (GAN) variant.

FIG. 1B is an illustration of another GAN variant.

FIG. 2A is an illustration of a semantic map with white representing brick walls, black representing concrete floor, and a yellow circle representing the base station (BS) location.

FIG. 2B is a 4×4 uniform planar array (UPA) antenna pattern in azimuth and elevation.

FIGS. 3A-3D illustrate: (A) example architecture of RADIANCE described herein including generator and discriminator network connections; (B) the design of the residual block used in constructing the generator; (C) the generator; and (D) the discriminator architecture in RADIANCE.

FIGS. 4A-4E are three dimensional (3D) views of the different floor plans along their corresponding radio frequency (RF) maps for 4×4 UPA at 28 GHz.

FIG. 5 is an illustration of the comparison between ray tracing simulated and RADIANCE synthesized RF maps for L-shaped rooms at different BS locations and center frequencies with the BS antenna being a 4×4 UPA.

FIG. 6 is an illustration of the comparison between simulated and synthetic RF maps generated using a 10×10 UPA at 28 GHz for different BS locations in Room 1 described herein.

FIG. 7 is an illustration of a computing device and exemplary methods steps associated with the inventive concept described herein.

Corresponding reference characters indicate corresponding elements among the view of the drawings. The headings used in the figures do not limit the scope of the claims.

### DETAILED DESCRIPTION

Aspects of the present disclosure relate to examples for radio-frequency adversarial deep-learning inference for automated network coverage estimation, dubbed and referred to herein as “RADIANCE”, including a generative adversarial network (GAN) based approach for synthesizing RF maps in indoor scenarios. In some examples, RADIANCE utilizes a semantic map, a high-level representation of the indoor environment to encode spatial relationships and attributes of objects within the environment and guide the RF map generation process. A new gradient-based loss function is introduced that computes the magnitude and direction of change in residual sum of squares (RSS) values from a point within the environment. RADIANCE incorporates this loss function along with the antenna pattern to capture signal propagation within a given indoor configuration and generate new patterns under new configuration, antenna (beam) pattern, and center frequency. Variations and various different applications are contemplated.

### I. Introduction

Radio-frequency coverage maps (RF maps) are vital in wire-communication, finding applications in network and capacity planning, interference coordination, resource allocation, localization, handoff management, and coverage estimation.

Technical Problems: However, collecting RF data and conducting site surveys is complicated due to the complex and dynamic nature of the wireless environment and the wide range of factors that can affect signal propagation, such as building materials, terrain, and interference. For example, for omnidirectional communications, it has been known to take about 11.9 hours to coarsely survey an area of 4500 meter' using only 475 reference points.

With the introduction of millimeter-wave (mmW) and sub-Terahertz (sub-THz) frequencies in 5G and beyond 5G (B5G) communication systems, RF map generation has become even more challenging. The signal propagation at these frequencies suffers from high atmospheric attenuation, limited penetration, susceptibility to shadowing, and inability to operate in non-line-of-sight (NLOS) scenarios. While atmospheric attenuation can be compensated for by using high-dimensional antenna arrays and beamforming techniques, blockage remains a key problem, making cell coverage highly dependent on the environment. Consequently, with the slightest changes in the environment and communication parameters, there are new scenarios to be investigated, which cannot be easily solved by the existing site survey techniques.

One potential solution to address the above challenges is to use ray tracing-based computer simulation to generate RF maps. Ray tracing techniques can accurately solve electromagnetic equations in complex environments, albeit at the expense of computational resources. Moreover, the efficacy of ray tracing relies on precise representations of the propagation environment, including 3D models of all objects and obstacles and their corresponding electromagnetic properties. Therefore, there is a need for a simple, fast, and cost-effective solution to generate RF maps.

To address these challenges, researchers have proposed various methods such as crowdsourcing and machine learning. Crowdsourcing involves collecting data from various user devices, which can be used to generate RF maps. However, aggregating data from heterogeneous devices is difficult, which may result in erroneous decisions. On the other hand, traditional machine learning techniques such as generalized linear models and k-nearest neighbors cannot provide fast and accurate results and may require the precise engineering of very complex networks.

Generative models have gained significant attention in cent times as a method of synthesizing datasets. Several extensions of generative adversarial network (GAN) models were applied to solve wireless communication problems. For instance, GAN-based models have been proposed for channel modeling, beamforming, anomaly detection, signal spoofing, and wideband channel estimation. In particular, GANs have been employed to generate additional measurements with improved diversity, thus expanding the training dataset, reducing data collection time, and saving human effort.

Kim et al. proposed a conditional GAN (cGAN) that extracts part of an RF map as a window, learns the indoor space in partitions, and combines the RF maps of various access points to generate a complete map. Zou et al. use a mobile robot to construct an RF map and estimate the RSS for new coordinates using Gaussian process regression conditioned least-squares-based GAN. Liu et al. determined the best Radio dot location using a dimension-conditional GAN with modified loss functions and a multi-stage training strategy from radio heatmap data collected by human experts. Njima et al. proposed a GAN for RSS data augmentation for indoor localization, which requires a small set of experimentally collected labeled data. Other authors proposed a framework called Supreme, a fine-grained RF map reconstruction scheme based on crowd-sourced data. They model a residual block (ResBlk) to explore spatial-temporal relationships in historical coarse-grained RF maps and build a real-time fine-grained RF map using deep spatial-temporal reconstruction networks.

In all the above works, a complete RF map was constructed based on incomplete data for a specific environment, BS location, center frequency, and antenna configuration. They fail to generate RF maps for a completely new environment or different network configurations. Thus, it limits the ability of the algorithms to adapt to changes in the environment as new sets of data need to be collected every time.

Technical Solution: To address this limitation, the subject disclosure proposes a novel and inventive approach called RADIANCE (Radio-frequency Adversarial Deep-learning Inference for Automated Network Coverage Estimation), which uses a modified cGAN structure to generate synthetic RF maps for any new indoor scenario and network configuration without the need for collecting new data. Specifically, RADIANCE uses a semantic map of the indoor radio environment that provides both spatial relationships and attributes of the objects within the environment, such as room geometry, position and type of materials, and their shapes. Further proposed is a gradient-based loss function that captures the signal propagation from the base station (BS) by computing the magnitude and direction of the changes of RSS at each point in the given indoor environment. RADIANCE incorporates this loss function along with the semantic map of the indoor environment and the antenna pattern of the transmitting BS enabling easy and cost-effective generation of realistic RF maps. The synthetic RF maps generated by RADIANCE is compared with RF maps generated using ray tracing-based simulation. It was observed that RADIANCE generates highly representative RF maps for any new floor plan, antenna configurations, and BS location while considering the specific center frequency. Moreover, compared to the ray tracing simulated RF maps, RADIANCE achieves a mean average error (MAE) of 0.09, root-mean-squared error (RMSE) of 0.29, peak signal-to-noise ratio (PSNR) of 10.78 and multi-scale structural similarity index (MS-SSIM) of 0.80. RADIANCE is clearly a technical improvement responsive to the technical problems described above.

The subsequent sections of this paper are structured as follows. Section II provides an overview of various GAN networks. Section III introduces the RADIANCE model and loss functions. Section IV presents the description of the dataset and the experimental evaluation of RADIANCE followed by conclusions in Section V.

### II. Generative Adversarial Networks

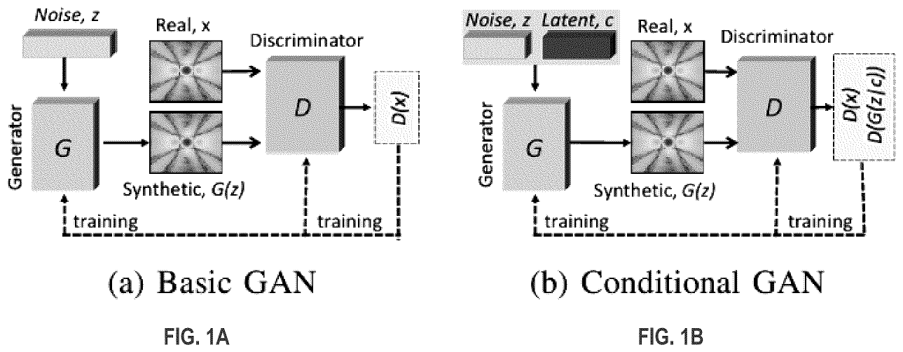

A basic GAN consists of two neural networks: A generator (G) and a discriminator (D), as depicted in FIG. 1 (A). G and D are trained simultaneously via an adversarial learning technique, which is essentially a two-player zero-sum min-max game played between G and D. Once the GAN has been trained, the game converges to a Nash equilibrium, where G and D cannot independently increase their payoff. At this convergence point, the min-max and maxi-min values are equal to −log 4. The objective function of a basic GAN can be formalized using the Jensen-Shannon divergence metric as follows:

$${min}_{G} {max}_{D} V ( G , D ) = {min}_{G} {max}_{D} ( {𝔼}_{x ∼ {p}_{z} ( z )} [ log ( D ( x ) ) ] + {𝔼}_{x ∼ {p}_{z} ( z )} [ log ( 1 - D ( G ( z ) ) ) ) . \qquad ( 1 )$$

Here, x is real data samples and z is noise. G(z) is a function that transforms a noise distribution (p_{z}) into an estimated data distribution (p_{g}). D(x) maps the input data distribution p_{data} to the range of [0, 1], indicating the likelihood of a sample being real and not generated by the generator.

In the design of the present inventive concept, a specific type of GAN called cGAN is employed to synthesize RF maps (see FIG. 1(B)). cGANs are powerful models that enable conditional generation of data. In addition to z, cGAN takes in extra conditioning information c, such as class labels or auxiliary input, to guide the generation of samples. In other words, a cGAN learns disentangled representations p_{data} by utilizing c as a conditioning factor for G. The objective function of a cGAN model is as follows:

$${min}_{G} {max}_{D} V ( G , D ) = {min}_{G} {max}_{D} ( {𝔼}_{x ∼ {p}_{data} ( x )} [ log ( D ( x \vert c ) ) ] + {𝔼}_{x ∼ {p}_{z} ( z )} [ log ( 1 - D ( G ( z \vert c ) ) ) ] ) . \qquad ( 2 )$$

cGAN is highly customizable, as one can learn the expected properties by combining various loss functions into the objective function and using corresponding conditions as input.

### III. Radiance Design

In this section, the design of the proposed RADIANCE is presented. A problem is first formulated, followed by discussion of the basic structure of RADIANCE in detail, and finally an explanation as to the various loss functions used to modify the GAN objective.

### A. Problem Setup

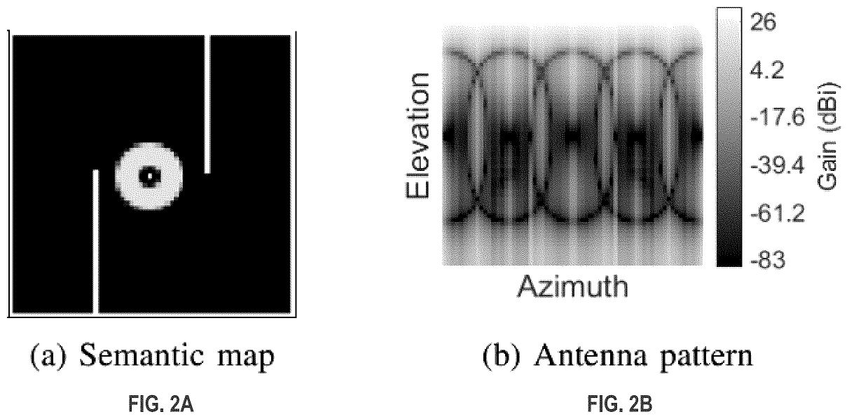

We focus on synthesizing new RF maps for indoor scenarios. Each floor plan i is characterized by an RF map xᵢ ∈ [symbol] and a semantic map sᵢ ∈ [symbol] , where l and w is the length and width of the RF maps. sᵢ provides information about the dimension, type, and location of objects within the floor plan i. As shown in FIG. 2(A), the semantic map represents a square-shaped room and reveals three features: a white structure indicating brick walls, a black background indicating a concrete floor, and a yellow circle indicating the BS location. Each RF map is characterized by the antenna pattern pᵢ ∈ [symbol] used at the BS. The antenna pattern is represented by the antenna gain values for various azimuth and elevation angles. An example of the antenna pattern for a 4×4 UPA is shown in FIG. 2(B). In order to incorporate the influence of transmission frequency, we employ a one-hot encoded categorical vector fᵢ o length k. This vector assigns a value of 1 to the specific center frequency, while all other values remain 0. Thus, the RF map xᵢ of each floor plan is conditioned by

cᵢ={sᵢ, pᵢ, fᵢ} (3)

Our goal is to train a generative model G(.) to synthesize RF maps for new and never before seen floor plans, BS location, and antenna configuration given center frequency, i.e.,

$${\tilde{x}}_{i} = G ( z \vert {c}_{i} ) ∈ {ℝ}^{l \times ω \times 3} . \qquad ( 4 )$$

### B. Radiance Architecture

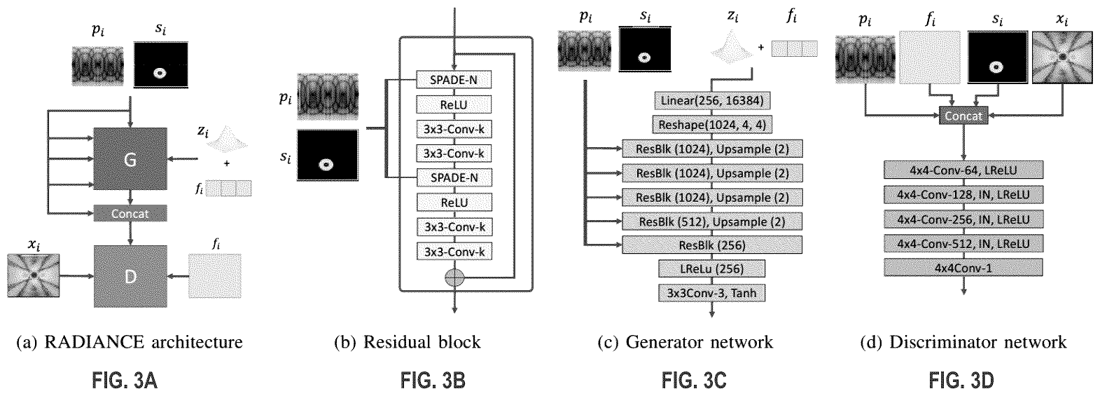

FIG. 3(A) presents the architecture of RADIANCE, which includes two types of neural networks: (i) a generator G and (ii) a discriminator D. The generator of RADIANCE is depicted in FIG. 3(C), along with the type of layers and their associated hyperparameters. The main building block of the generator is a modified residual block (ResBLK) which includes a spatially-adaptive normalization layer (SPADE—followed by a rectified linear (ReLU) layer and stacks of two convolutional (Conv) layers. We use upsampling to upsample the input after each ResBlK. Finally, the generator produces RF maps given the input z and cᵢ.

We can use a PatchGAN discriminator with instance normalization (IN), and leaky ReLu (LReLu) activation function as shown in FIG. 3D. The discriminator tries to differentiate between real and synthetic RF maps. The input to the discriminator is a concatenation of the semantic map, the antenna pattern, the real or synthetic RF map, and a one-hot encoded matrix. This one-hot encoded matrix has a dimension of l×w×k and is generated from the one-hot encoded vector fᵢ. The output of the discriminator is a 5×5 patch matrix indicating whether the image patch is real or fake.

### C. Loss Function

Mean absolute error loss: Mean absolute error loss L_{MAE} captures the average difference between corresponding pixel values and provides a straightforward and interpretable measure of dissimilarity between xᵢ and \tilde{x}ᵢ. For example, for n generated samples, it is represented as:

$${L}_{MAE} = \frac{1}{n} {\sum }_{1}^{n} \vert {x}_{i} - {\tilde{x}}_{i} \vert \qquad ( 5 )$$

Focal loss: In RF maps, pixels representing high RSS values are crucial in applications like localization and radio network planning. Focal loss L_{FL} compels the model to assign greater importance to important pixels in the RF map, thereby amplifying the influence of high RSS value pixels on the training process and the final decision.

Feature matching loss: To ensure intermediate features align properly, the feature matching loss L_{FM} incentivizes G to grasp the high-level structure and semantics of the ground truth data. This promotes the generation of visually captivating and realistic samples. L_{FM} can be computed as follows:

$${L}_{FM} = \frac{1}{m} {\sum }_{i = 1}^{m} \{ {‖ {Q}^{{x}_{i}} - {Q}^{{\tilde{x}}_{i}} ‖}_{2}^{2} \} . \qquad ( 6 )$$

Here, m denotes the number of feature maps, and Q^{x}^{ᵢ} and Q^{\tilde{x}}^{ᵢ} represents features extracted from xᵢxᵢ and \tilde{x}ᵢ. We use D to extract the feature maps.

VGG Feature matching loss: VGG feature matching loss L_{VGG} is a variant of L_{FM} that leverages features extracted by a VGG network for GAN training. By using L_{VGG}, G is incentivized to produce samples that not only deceive D at a high-level feature representation level but also capture the intricate details and textures found in real samples.

Gradient loss: By inspecting the RF maps, we observe that the distribution of the RSS depends on the antenna pattern. The signal propagates smoothly along the antenna's boresight, but there are abrupt changes in the RSS between the boresight and the null direction. To capture these effects, we use a gradient loss (L_{GL}). Basically, we use Sobel filer to obtain the gradient of xᵢ and \tilde{x}ᵢ, i.e., ∇xᵢ and ∇\tilde{x}ᵢ. The magnitude of the gradient tells us how quickly the RSS is changing, while the direction of the gradient tells us the direction in which the RSS is changing most rapidly. To measure L_{GL}, we determine the changes in the magnitude and direction between ∇xᵢ and ∇\tilde{x}ᵢ using KL-divergence (KL) and cosine similarity (CS), respectively. Thus we can write L_{GL} as

$${L}_{GL} = \frac{1}{n} {\sum }_{1}^{n} ( KL ( ∇ {x}_{i} , ∇ {\tilde{x}}_{i} ) + CS ( ∇ {x}_{i} , ∇ {\tilde{x}}_{i} ) ) \qquad ( 7 )$$

Based on the above loss functions, we can rewrite the total generator loss function as follows:

$${L}_{Total} = {L}_{G} + {λ}_{mae} {L}_{MAE} + {λ}_{fl} {L}_{FL} + {λ}_{fm} {L}_{FM} + {λ}_{vgg} {L}_{VGG} + {λ}_{gl} {L}_{GL} \qquad ( 8 )$$

where λₘₐₑ, λ_{fl}, λ_{fm}, λ_{vgg}, and λ_{gl} are the weights of the corresponding loss functions.

### IV. Experimental Results

In this section, we first describe our dataset and then provide a detailed report on the performance of RADIANCE in synthesizing new RF maps.

### A. Dataset Generation

It is imperative to note that obtaining practical measurements for generating ground truth RF maps is crucial for validating the accuracy of RADIANCE. In this study, we rely on ray tracing simulations as they are highly accurate and can be used to obtain multiple coverage maps.

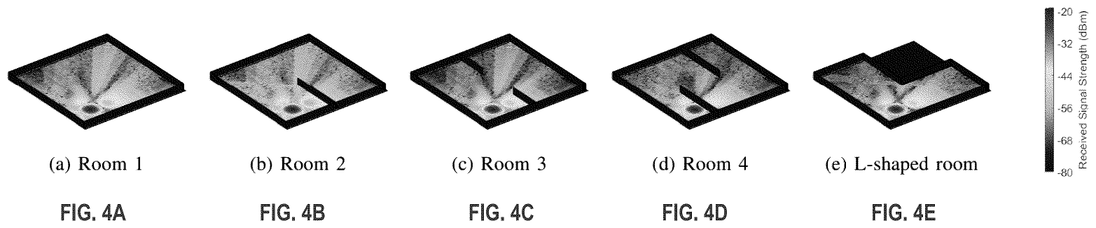

In this paper, we employ MATLAB-based ray tracing simulations to generate RF maps for training and validating the RADIANCE model. Specifically, we use the shooting and bouncing ray (SBR) method to generate the propagation paths between the BS and multiple receivers (RX). We generate RF maps for various center frequencies, antenna patterns, and BS locations, considering five different indoor scenarios. These scenarios have a consistent dimension of 10×10 meters but differ in their geometries. The floor plans, illustrating the layouts of these scenarios along with their corresponding RF maps for a 4×4 UPA at 28 GHz, are depicted in FIGS. 4A-4E We assume the walls are constructed of brick material, and the floor is made of concrete. These parameters can be easily adjusted and modified as necessary.

In order to generate an RF map, we divide the room area into a 64×64 grid, with each grid of size 0.024 meter² for all the floor plans. We consider that each RX is equipped with an isotropic antenna with an omnidirectional pattern. In contrast, we employ uniform planar arrays (UPA) with patch antenna elements at the BS. The dimensions of the UPAs considered are 4×4, 6×6, 8×8, 10×10, and 12×12. Moreover, we consider three carrier frequencies: 5 GHz, 28 GHz, and 70 GHz. A single BS is placed 3 meters above the ground in each grid tile, with the antenna's broadside facing downwards along the Z-axis, from the ceiling towards the floor. We place a grid of RXs occupying all grid tiles in the floor plan. The RX grid is placed at a height of 1.5 meters. Generally, indoor BSs do not employ beam tracking; thus, we maintain a fixed BS beam direction. In other words, we let the antenna beam's boresight align with the antenna array's broadside. The RSS values are measured for the RX grid and are used to generate a coverage heatmap. Table I provides the values of the key configuration parameters, including operating frequencies, material types, BS/RX configurations, etc. The dataset consists of 74,752 samples in total.

TABLE I
Simulation Parameters

| Parameter | Description | Value Frequency | |
|---|---|---|---|
| Frequency | sub-6 GHz | 5 | GHz |
| | mmWave | 28, 70 | GHz |
| Wall | Height | 4 | meters |
| | Material | Brick | |
| Floor | Material | Concrete | |
| Base station | Transmit Power | 0 | dBm |
| | Height | 3 | meters |
| BS antenna | Uniform planer array | 4 × 4 | |
| | | 6 × 6 | |
| | | 8 × 8 | |
| | | 10 × 10 | |
| | | 12 × 12 | |
| Receiver | Height | 1.5 meters Isotropic | |
| | Antenna | antenna | |
| Floor Plans | Dimensions | 10 × 10 | meters |

### B. Evaluation

GANs can generate realistic samples by accurately modeling complex multi-dimensional data. However, assessing the performance of GANs is difficult, and various evaluation techniques have been proposed in the literature. Most of these techniques rely on visual inspection of the synthesized data samples, while others, such as the RMSE and MS-SSIM, quantitatively compare GAN-generated data with the ground truth. In this section, we evaluate the performance of RADIANCE in synthesizing new RF maps.

We evaluate the performance of RADIANCE in performing two different tasks. For Task 1, we fix the antenna pattern to 4×4 UPA and want RADIANCE to generate RF maps for completely new floor plans and BS locations, for different center frequencies. In Task 2, we fix the floor plan and the center frequency and want RADIANCE to synthesize RF maps for completely new antenna patterns and BS locations. For each task, we first visually compare the generated synthetic RF maps with the ray trace simulated maps and then compute the MAE, RMSE, PSNR, and MS-SSIM to compare them quantitatively.

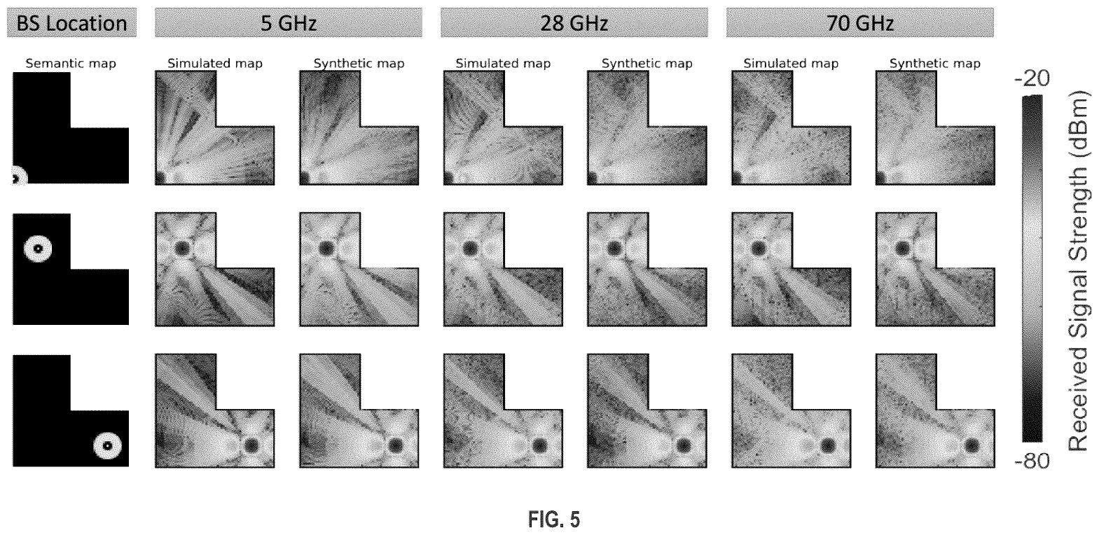

For Task 1, we select Rooms 1 to 4 (see FIG. 4) and their corresponding features as the training set. For the test set, we consider the L-shaped room and its corresponding features. As seen in FIG. 5, for different BS locations (depicted by the yellow circle in the semantic map) and center frequencies, RADIANCE was able to generate representative RF maps for an L-shaped floor plan which has a completely different geometry than Rooms 1 to 4. Moreover, for Task 1, RADIANCE achieves MAE of 0.06, RMSE of 0.23, PSNR of 12.81, and MS-SSIM of 0.91. The results are provided in Table. II. The best value one can expect from this comparison is also represented in column 2 in the table.

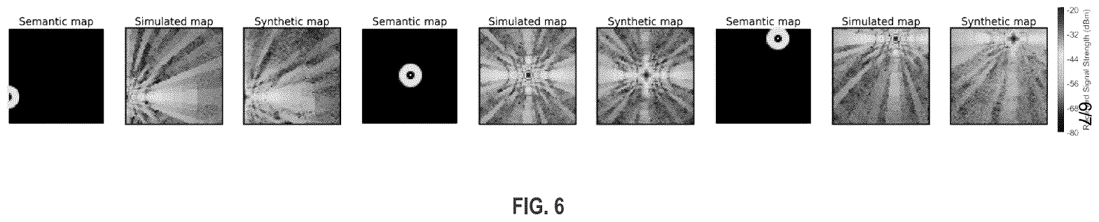

For Task 2, we fix the room geometry to Room 1 and the center frequency to 28 GHz for both the training and test set. But for the training set, we consider different UPAs of dimension 4×4, 6×6, 8×8, 10×10, and 12×12 UPA. As for the test set, we only consider 10×10 UPA. The goal is to see if RADIANCE can generate RF maps for completely new antenna configurations at different BS locations within the floor plan. FIG. 6 depicts the results for Task 2. The synthetic RF maps are visually similar to the simulated RF maps. In terms of MAE, RMSE, RSNR, and MS-SSIM, it achieves a value of 0.13, 0.36, 8.75, and 0.70, respectively.

TABLE II
RADIANCE Performance

| Parameter | Best Value | Task 1 | Task 2 | Avg. |
|---|---|---|---|---|
| MAE | 0 | 0.06 | 0.13 | 0.09 |
| RMSE | 0 | 0.23 | 0.36 | 0.29 |
| PSNR | inf | 12.81 | 8.75 | 10.78 |
| MS-SSIM | 1 | 0.91 | 0.70 | 0.80 |

### V. Conclusion

This paper proposed RADIANCE, a conditional GAN-based method for synthesizing RF maps for given wireless communication attributes. The framework incorporated modified neural network architectures for the generator and discriminator. Moreover, a new gradient-based loss function was proposed to capture signal propagation effects. The synthesized RF maps resemble those produced by ray tracing simulations, as confirmed by both visual and quantitative evaluations.

RADIANCE currently supports specific floor plan dimensions and center frequencies, limiting its generalizability. Thus, restrictions exist concerning dimension and frequency flexibility. Our future work includes verifying the model with different experimental datasets, modifying the architecture to accommodate different floor plan dimensions and center frequencies, and investigating the impact of furniture orientation within rooms.

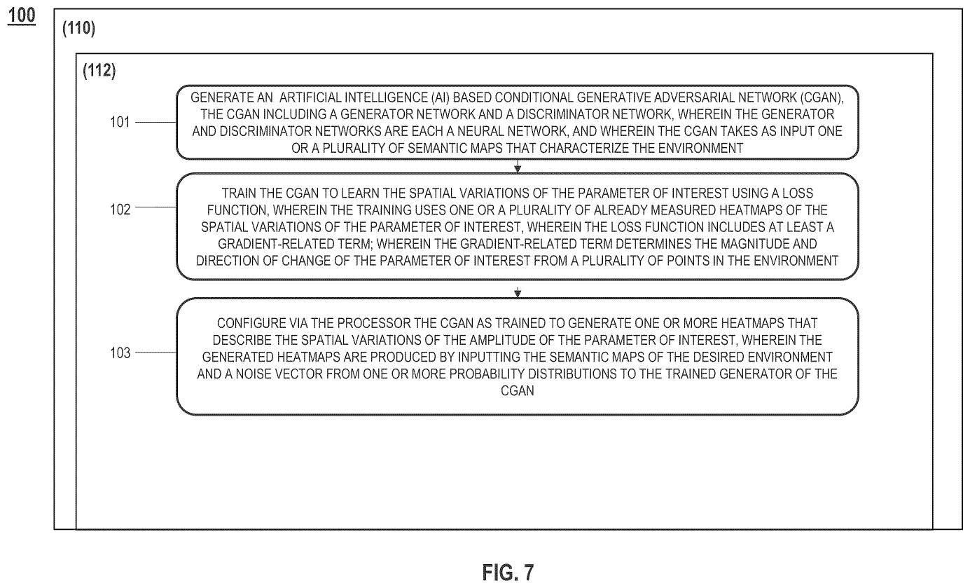

FIG. 7 is a simplified illustration of a computing device 100 configured to execute a series of steps including (but not limited to) steps 101-103. The steps 101-103 can be implemented as machine-readable instructions stored in a memory 112 and executed by a processor 110.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method for generating one or a plurality of heatmaps for visualizing the spatial variations of the amplitude of a parameter of interest in an environment, the method comprising:
generating, via a processor, an artificial intelligence (AI) based conditional generative adversarial network (cGAN), the cGAN including a generator network and a discriminator network, wherein the generator and discriminator networks are each a neural network, and wherein the cGAN takes as input one or a plurality of semantic maps that characterize the environment;
training, via the processor, the cGAN to learn the spatial variations of the parameter of interest using a loss function, wherein the training uses one or a plurality of already measured heatmaps of the spatial variations of the parameter of interest, wherein the loss function includes at least a gradient-related term; wherein the gradient-related term determines the magnitude and direction of change of the parameter of interest from a plurality of points in the environment;
configuring via the processor the cGAN as trained to generate one or more heatmaps that describe the spatial variations of the amplitude of the parameter of interest, wherein the generated heatmaps are produced by inputting the semantic maps of the desired environment and a noise vector from one or more probability distributions to the trained generator of the cGAN.

2. The method of claim 1, wherein a heatmap of the one or more heatmaps characterizes the spatial variations of a radio frequency (RF) signal in an environment.

3. The method in claim 2, wherein the RF signal is a directional signal transmitted over a high-frequency band.

4. The method of claim 1, wherein the semantic maps are comprised of a plurality of digital representations of attributes that characterize the one or more of the geometry of the environment, the locations of objects within the environment, the conductivity of these objects, the reflectivity of these objects, the locations of one or more RF transmitters in the environment, the antenna patterns of these transmitters, and the center frequency of these transmitters.

5. The method of claim 1, wherein the generated heatmaps are related to an environment that is the same or different from the environment used during the training of the cGAN, wherein the different environment is characterized by one or more semantic maps.

6. The method of claim 1, wherein at least one of these semantic maps is different from the corresponding semantic map of the original environment used for the training process.

7. The method of claim 1, wherein the neural network used for the generator of the cGAN is comprised of a Linear neural network layer, a Reshape layer, a plurality of residual blocks, a leaky-rectified linear unit activation function, and a convolutional layer; wherein the residual blocks is each comprised of two SPADE-N normalization layers, four convolutional layers and a ReLU activation function.

8. A system for generating a plurality of heatmaps for visualizing the spatial variations of the amplitude of a parameter of interest in an environment; the system comprised of:
a processor in communication with a memory, the memory including instructions, which, when executed, cause the processor to:
access a plurality of input parameters associated with an environment, the plurality of parameters comprised of one or more semantic maps that encode a plurality of spatial relationships and attributes of objects within the environment, and that guides the generation process of heatmaps;
access a modified conditional generation adversarial network (cGAN) that is trained to learn the statistical variations of the parameter of interest in an environment; wherein these statistical variations are conditioned on one or more semantic maps of the environment;
configure the trained cGAN to generate new heatmaps for the same or for different environments than the environment considering during the training of the cGAN; wherein a different environment is produced by modifying one or more semantic maps used in the training process.

9. The system of claim 8, wherein a heatmap characterizes the spatial variations of a radio frequency (RF) signal in an environment; and wherein the semantic maps used to generate the heatmaps are comprised of a plurality of digital representations of attributes that characterize the one or more of the geometry of the environment, the locations of objects within the environment, the conductivity of these objects, the reflectivity of these objects, the locations of one or more RF transmitters in the environment, the antenna patterns of these transmitters, and the center frequency of these transmitters.

10. The system of claim 9, wherein the RF signal is a directional signal, transmitted over a high-frequency band.
